(19) United States
(12) Patent Application Publication
(10) Pub. No.: US 2019/0071057 A1
(43) Pub. Date: Mar. 7, 2019

(54) METHOD FOR PRODUCING A WINDOW WASH NOZZLE, AND WINDOW WASH NOZZLE

(71) Applicant: ILLINOIS TOOL WORKS INC., Glenview, IL (US)

(72) Inventors: Martin KLUGE, Röttingen (DE); Florian Düll, Röttingen (DE)

(73) Assignee: ILLINOIS TOOL WORKS INC., Glenview, IL (US)

(21) Appl. No.: 16/084,499

(22) PCT Filed: Feb. 28, 2017
(86) PCT No.: PCT/US2017/019917

§ 371 Date: Sep. 12, 2018

(30) Foreign Application Priority Data
Mar. 30, 2016 (DE) 10 2016 105 748.7

(51) Int. Cl. B60S 1/52; B05B 1/04

(52) U.S. Cl. CPC B60S 1/52; B29C 45/0055; B05B 1/04

(57) ABSTRACT

A method for producing a window wash nozzle for cleaning a vehicle window, includes the following steps: (i) a nozzle body with a supply duct and a first outlet opening, which is connected to the supply duct, is produced in an injection molding process, wherein, for the operation of the window wash nozzle, the supply duct is connectable to a liquid supply, and wherein, during the operation of the window wash nozzle, a fan-shaped liquid jet or a liquid jet oscillating in a fan-shaped manner is discharged through the first outlet opening, (ii) following the injection molding process, at least one second outlet opening is introduced into the nozzle body by drilling, said second outlet opening being connected to the supply duct, and through which a non-oscillating liquid spot jet is discharged during the operation of the window wash nozzle. A resulting window wash nozzle configuration is also provided.

The invention relates to a method for producing a window wash nozzle for cleaning a vehicle window. In addition, the invention relates to a window wash nozzle for cleaning a vehicle window.

Window wash nozzles are used in cars in order to clean, for example, the windshield. For this purpose, the window wash nozzle is supplied under pressure with a cleaning liquid, for example a mixture of water and a cleaning component and optionally an antifreeze agent. The window wash nozzle discharges the liquid onto the vehicle window. For extensive cleaning of the vehicle window, it is known to discharge fan-shaped liquid jets or liquid jets oscillating in a fan-shaped manner from the window wash nozzles. Such window wash nozzles are known, for example, from U.S. Pat. No. 4,645,126 A or EP 2 144 702 B1.

However, there are regions of vehicle windows which cannot be sufficiently cleaned even with such fan-shaped liquid jets. This relates, for example, to regions to which access is difficult at the edge of the vehicle window or regions with a particular cleaning requirement, for example window regions under which sensors, for example cameras for vehicle assistance systems, are arranged. For the cleaning of such regions, non-oscillating liquid spot jets can be additionally discharged from the window wash nozzles and are directed in a targeted manner onto the corresponding window regions.

Window wash nozzles are produced in the prior art in an injection molding process. During the injection molding process, ducts etc. provided within the window wash nozzle, and also the outlet openings for fan-shaped liquid jets and optionally the non-oscillating liquid spot jets are formed. Outlet openings for liquid spot jets having the required small diameters can thereby be readily produced.

However, only a certain configuration of the window wash nozzle, in particular of the outlet openings, can ever be produced with an injection molding die. This applies to the arrangement and orientation of the outlet openings and also to the geometry thereof. If other outlet openings are intended to be produced, for example for a different type of vehicle, the injection molding die has to be correspondingly changed. This is associated with a high outlay. It has therefore also already been proposed to design outlet openings to be adjustable, for example by means of a ball and socket joint arrangement. By rotation of the ball and socket joint arrangement, at least the orientation of the outlet openings can then be changed. However, the geometry of the outlet openings cannot be changed in this manner. In addition, such window wash nozzles are complicated in respect of their design and are also susceptible to faults in practice. The installation is also complicated since the ball and socket joint arrangement has to be adjusted in each case for the desired orientation of the outlet openings.

Starting from the explained prior art, the invention is therefore based on the object of providing a method and a window wash nozzle of the type mentioned at the beginning, wherein the window wash nozzle is intended to be simplified in respect of production, design and installation while maintaining the greatest possible flexibility in respect of the orientation, arrangement and geometry of the outlet openings.

The invention achieves this object by means of independent claims 1 and 7. Advantageous refinements are found in the dependent claims, the description and the figures.

The invention achieves the object, firstly, by a method for producing a window wash nozzle for cleaning a vehicle window, comprising the following steps:
a nozzle body with a supply duct and a first outlet opening, which is connected to the supply duct, is produced in an injection molding process, wherein, for the operation of the window wash nozzle, the supply duct is connectable to a liquid supply, and wherein, during the operation of the window wash nozzle, a fan-shaped liquid jet or a liquid jet oscillating in a fan-shaped manner is discharged through the first outlet opening,
following the injection molding process, at least one second outlet opening is introduced into the nozzle body by drilling, said second outlet opening likewise being connected to the supply duct, and through which a non-oscillating liquid spot jet is discharged during the operation of the window wash nozzle.

The invention achieves the object, secondly, by a window wash nozzle for cleaning a vehicle window, comprising a nozzle body in which a supply duct which is connectable at one end to a liquid supply and is connected at the other end to a first outlet opening of the nozzle body is formed, wherein, during the operation of the window wash nozzle, a fan-shaped liquid jet or a liquid jet oscillating in a fan-shaped manner is discharged through the first outlet opening, wherein the supply duct is furthermore connected to at least one second outlet opening of the nozzle body, through which a non-oscillating liquid spot jet is discharged during the operation of the window wash nozzle, wherein the at least one second outlet opening has been introduced into the nozzle body by drilling.

The window wash nozzle can serve in particular for cleaning a window of a car, for example a windshield. Ducts etc. formed in the nozzle body can be open toward one or more sides, for example toward an upper side and a lower side. The nozzle body can subsequently be closed for the operation by a cover plate of the window wash nozzle, said cover plate being placed onto the nozzle body, or by a housing of the window wash nozzle, said housing receiving the nozzle body, for example by pressing. However, it is also possible to form a (hollow) nozzle body with closed ducts, etc., during the injection molding process. The nozzle body can be composed of a suitable plastic. For example, the nozzle body can be composed of a polymer.

The supply duct is connected to a liquid supply during the operation of the window wash nozzle. By means of the liquid supply, the supply duct is supplied under pressure with liquid, for example water with a cleaning component and optionally an antifreeze component, from a reservoir. For this purpose, a suitable pump can be provided, as is known per se. The liquid firstly emerges from the first outlet opening of the nozzle body. By means of a suitable design of the nozzle body or of the first outlet opening, the jet can already emerge here from said outlet opening in a fan-shaped manner. For this purpose, the first outlet opening can have, for example, a multiplicity of small holes. However, it is also possible for a spot jet oscillating in a fan-shaped manner to emerge from the first outlet opening. This appears as a fan-shaped jet to a human eye because of the high oscillation frequency. Furthermore, at least one second outlet opening is provided through which a (non-oscillating) spot jet emerges. Said spot jet is therefore substantially not expanded and impinges against a narrowly defined region of the window to be cleaned. This may be in particular a vehicle window region to which access is difficult or is particularly in need of cleaning, for example a vehicle window region behind which sensors, for example cameras for assistance systems of the car, are located.

According to the invention, the at least one second outlet opening is introduced into the nozzle body by drilling, in particular subsequently to the injection molding process. The drilling method can be in particular a contactless drilling method. The drilling can be in particular thermal drilling, in which the nozzle body material is melted and/or evaporated by means of a suitable heat source in the region of the second outlet opening to be formed. This can therefore be a non-machining drilling method. According to the invention, the nozzle body with the first outlet opening, which is generally not to be changed in respect of arrangement and orientation, including the respectively required liquid ducts or interaction chambers, is formed in the injection molding process using the injection molding die which is configured uniquely for this purpose. By contrast, in the method according to the invention, the second outlet openings which are required in different ways in different types or configurations of vehicles, are only incorporated by drilling in a working step subsequent to the injection molding process. This approach achieves maximum flexibility in respect of the orientation, arrangement and geometry of the second outlet openings. In particular, the injection molding die does not have to be changed to adapt it to a changed configuration. By means of suitable drilling methods, the second outlet openings can be produced with consistently high precision in the respectively desired configuration, in particular even with the small diameters required in this connection. In this manner, adjustability of the second outlet openings, for example by a ball and socket arrangement, can also be dispensed with. The window wash nozzle according to the invention can therefore be designed, produced and fitted more simply. At the same time, there is the greatest possible flexibility in respect of the design of the second outlet openings. The basic model of the nozzle body that is produced in the injection molding process can be used for a very wide variety of types and configurations of vehicle.

According to the invention, a plurality of such window wash nozzles can also be produced successively with drilled second outlet openings formed in different ways. The outlet openings can differ in particular in respect of their shape and/or their diameter and/or their arrangement and/or their orientation.

According to a particularly practical configuration, the at least one second outlet opening can be introduced into the nozzle body by laser drilling. During the laser drilling, the material of the nozzle body is melted and/or evaporated in the region of the second outlet opening to be formed. This involves a contactless thermal drilling method which permits a highly precise formation of the desired shape, orientation and arrangement of the second outlet openings in a reliably reproducible manner even for the smallest cross sections of the second outlet openings. It is therefore very readily suitable for the present application purpose. However, other drilling methods, for example ultrasonic drilling methods, are basically also conceivable.

According to a further refinement, it can be provided that at least one distribution duct, which is connected to the supply duct, is furthermore formed in the nozzle body in the injection molding process, wherein the at least one second outlet opening is connected to the at least one distribution duct. The distribution duct or the distribution ducts is/are therefore already placed in the nozzle body during the injection molding process. The at least one distribution duct ends below the surface of the nozzle body. By means of drilling through said surface, a connection of the distribution duct to the outside in the form of the second outlet opening is then produced. Although the distribution duct is therefore already applied from the outset in the injection molding process, second outlet openings of differing design can be flexibly produced by different drilling directions and drilling methods and connected to the distribution duct.

It is also possible that, subsequently to the injection molding process, a plurality of second outlet openings are introduced into the nozzle body by drilling and are connected to the supply duct and through which a non-oscillating liquid spot jet is in each case discharged during the operation of the window wash nozzle. Furthermore, a plurality of distribution ducts, which are connected to the supply duct, can then be formed in the nozzle body during the injection molding process, wherein the plurality of second outlet openings are connected to the distribution ducts. The second outlet openings can each be connected to one of the distribution ducts. However, it is also possible for a plurality of the second outlet openings to be connected to a distribution duct. The plurality of second outlet openings can be oriented in different directions. The spot-shaped liquid jets emerging through said outlet openings during the operation then emerge in different directions and thus impinge against different regions of a vehicle window to be cleaned. The plurality of second outlet openings can also have a differing geometry, for example differing diameters and/or cross sections tapering or expanding differently, etc. The window wash nozzle can thus be adapted in a simple manner to the individual requirements.

According to a further refinement, the nozzle body can be formed with at least one convexly curved outer surface in the injection molding process, wherein the at least one second outlet opening is introduced in the region of the convexly curved outer surface. For example, two convexly curved outer surfaces formed symmetrically with respect to the first outlet opening can be provided. The at least one convexly curved outer surface can be, for example, of (semi)spherical design. A consistent basis for the drilling of the second outlet openings is thereby provided. This relates in particular to the wall thickness, i.e. the longitudinal extent of the bore, and to the outlet angle. By means of the convex curvature, second outlet openings can be drilled from very different directions without undesirable variations in the conduction of the liquid in the region of the outlet occurring.

According to a further exemplary embodiment, it can be provided that an interaction chamber which is connected at one end to the supply duct and at the other end to the first outlet opening is formed in the nozzle body in the injection molding process, wherein varying vortices form in the interaction chamber during the operation of the window wash nozzle in such a manner that a liquid jet oscillating in a fan-shaped manner is discharged from the first outlet opening. Such a configuration is basically known, as explained at the beginning.

With the method according to the invention, in particular a window wash nozzle according to the invention can be produced. In a corresponding manner, the window wash nozzle according to the invention can have been produced with the method according to the invention.

An exemplary embodiment of the invention is explained in more detail below with reference to figures, in which, schematically:

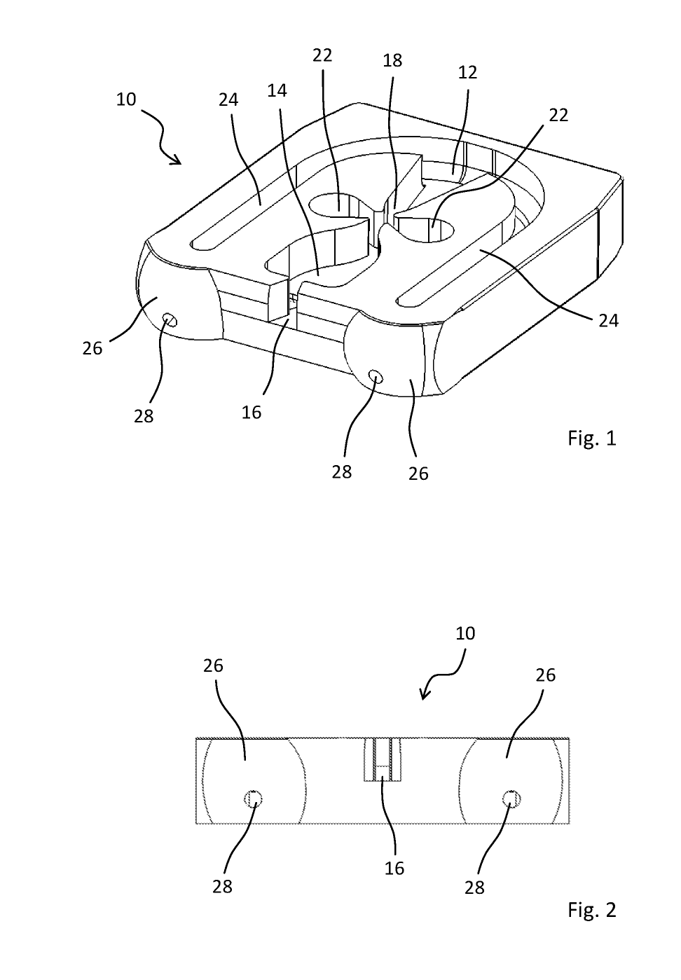

FIG. 1 shows a nozzle body of a window wash nozzle according to the invention in a perspective view,

FIG. 2 shows the nozzle body from FIG. 1 in a view from the front,

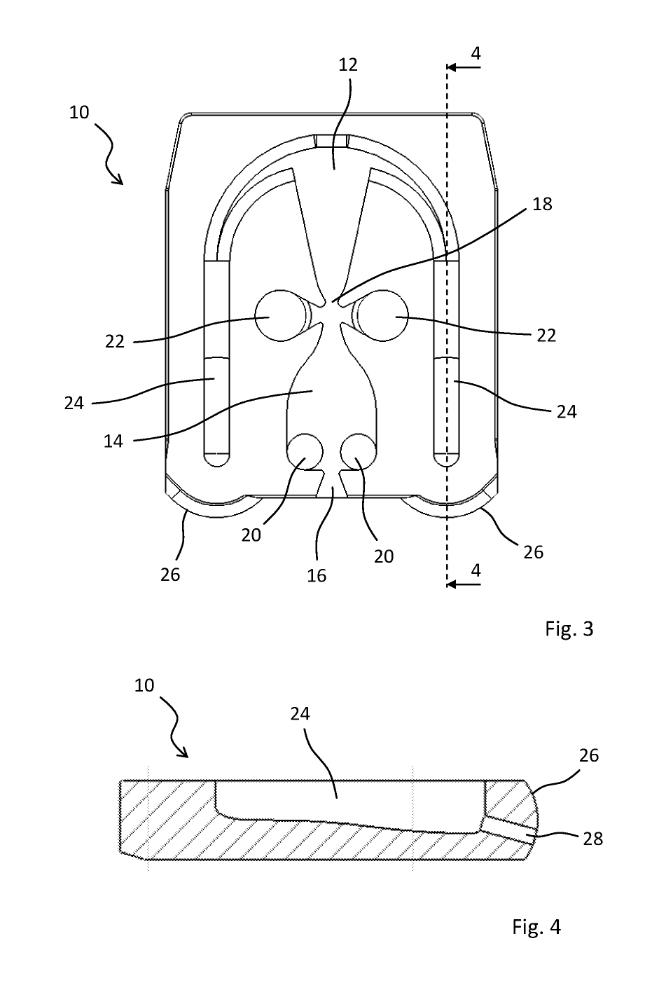

FIG. 3 shows the nozzle body from FIG. 1 in a view from above,

FIG. 4 shows a sectional view along the line 4-4 in FIG. 3,

FIG. 5 shows the nozzle body from FIG. 1 in a view from below, and

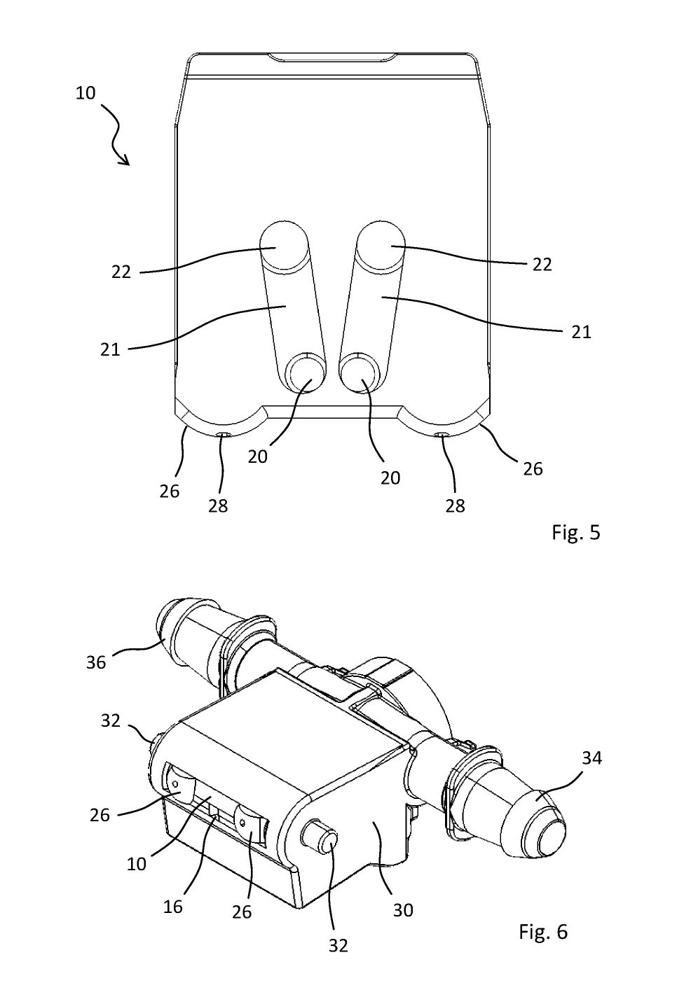

FIG. 6 shows the nozzle body from FIG. 1 in the state inserted into a housing.

Unless stated otherwise, the same reference signs refer in the figures to the same objects.

The nozzle body 10 shown in the figures is composed of a plastic and has a cuboidal basic shape. Various ducts are formed in the nozzle body 10, as will be explained in more detail below. For the operation, the nozzle body 10 is inserted into a housing, as will likewise be explained in more detail below.

A supply duct 12 is formed in the nozzle body, said supply duct being connected to a liquid supply during the operation of the window wash nozzle comprising the nozzle body 10. The liquid supply comprises a pump through which liquid, in particular a mixture of water and a cleaning liquid and optionally an antifreeze agent, is supplied under pressure to the supply duct 12. During the operation, the window wash nozzle equipped with the nozzle body 10 serves for cleaning a vehicle window, in particular a window of a car. The supply duct 12 opens into an interaction chamber 14 which is likewise formed in the nozzle body 10. The interaction chamber 14 in turn opens into a first outlet opening 16 via which the liquid supplied to the supply duct 12 emerges oscillating in a fan-shaped manner during the operation and impinges on the vehicle window. In the example illustrated, the supply duct 12 opens into the interaction chamber 14 via a constriction 18. In addition, circulation bores can be seen at the reference signs 20, 22. The circulation bores 20, 22 are connected to each other by connecting ducts 21, which are provided on the lower side, shown in FIG. 5, of the nozzle body 10, in such a manner that liquid passing from the supply duct 12 into the interaction chamber 14 and not emerging through the first outlet opening 16 can flow back through the circulation bores 20, the connecting ducts 21 and the circulation bores 22 and can then enter the interaction chamber 14 again. During the operation, this configuration leads to the formation of vortices in the interaction chamber 14 and to liquid flowing back via the circulation bores 20, 22 and the connecting ducts 21 in an alternating manner on the one side and on the other side of the interaction chamber 14. This leads to the liquid jet emerging from the first outlet opening 16 oscillating rapidly to and fro and thus to a fan-shaped oscillation of the liquid arising.

Furthermore, two distribution ducts 24 which are connected to the supply duct 12 are formed in the nozzle body 10. The distribution ducts 24 are arranged mirror-symmetrically to a center axis of the nozzle body 10, said center axis running between the supply duct 12 and the first outlet opening 16, and end in each case below an outer surface 26 which is convexly curved hemispherically. A second outlet opening 28 in each case connecting one of the distribution ducts 24 to the outer side is formed in each of the convexly curved outer surfaces 26. During the operation of the window wash nozzle, a non-oscillating liquid spot jet emerges through said second outlet openings 28. It can impinge against regions of the window to be cleaned that are particularly in need of cleaning.

FIG. 6 shows the nozzle body 10, which is shown in FIGS. 1 to 5, in the state inserted into a housing 30 of the window wash nozzle. The nozzle body 10 can be held in the housing 30 in particular by means of a press fit. In the state inserted into the housing 30, the circulation bores 20, 22, connecting ducts 21, interaction chamber 14 and distribution ducts 24, which can be seen in FIGS. 1 to 5 and are open toward the upper side or lower side of the nozzle body 10, are tightly closed. Only the first and second outlet openings 16, 28 for the liquid to be discharged and also a connection to the supply duct 12 therefore remain as a connection to the surroundings. Via first and second inlet connections 34, 36, the supply duct 12 is supplied with liquid under pressure from a liquid reservoir, as is known per se. In addition, two cylindrical projections on the outer side of the housing 30 can be seen at the reference sign 32. The housing 30 is inserted into a housing receptacle on the vehicle. The cylindrical projections 32 serve as an axis of rotation via which the rotational position of the housing 30 together with the nozzle body 10 can be adjusted for the operation.

The nozzle body 10 was produced apart from the second outlet openings 28 in a plastics injection molding process. After the injection molding step, the second outlet openings 28 were introduced into the nozzle body 10 by means of laser drilling. In this way, the second outlet openings 28 can be formed simply and flexibly in respect of production, design and installation. The housing 30 with the inlet connections 34, 36 can also have been produced in an injection molding process, for example from a plastic.

1-12. (canceled)

13. A method for producing a window wash nozzle for cleaning a vehicle window, comprising the following steps:
a nozzle body with a supply duct, and a first outlet opening connected to the supply duct, is produced in an injection molding process, wherein, in operation of the window wash nozzle, the supply duct is connectable to a liquid supply, and wherein the first outlet opening is configured such that, during operation of the window wash nozzle, a fan-shaped liquid jet or a liquid jet oscillating in a fan-shaped manner is discharged through the first outlet opening,
following the injection molding process, at least one second outlet opening is introduced into the nozzle body by drilling, said second outlet opening also being connected to the supply duct, and said second outlet opening be configured such that, during operation of the window wash nozzle, a non-oscillating liquid spot jet is discharged through the second outlet opening.

14. The method as claimed in claim 13, wherein the at least one second outlet opening is introduced into the nozzle body by laser drilling.

15. The method as claimed in claim 13 wherein at least one distribution duct, which is connected to the supply duct, is furthermore formed in the nozzle body by the injection molding process, wherein the at least one second outlet opening is connected to the at least one distribution duct.

16. The method as claimed in claim 13, wherein the nozzle body is formed with at least one convexly curved outer surface in the injection molding process, wherein the at least one second outlet opening is introduced in a region of the convexly curved outer surface.

17. The method as claimed in claim 13 wherein an interaction chamber, which is connected at a first end to the supply duct and at a second end to the first outlet opening, is formed in the nozzle body in the injection molding process, wherein the interaction chamber is configured so that varying vortices form in the interaction chamber during operation of the window wash nozzle in such a manner that a liquid jet oscillating in a fan-shaped manner is discharged from the first outlet opening.

18. A window wash nozzle for cleaning a vehicle window, comprising a nozzle body with an internal supply duct that is connectable at one end to a liquid supply and is connected at another end to a molded outlet opening of the nozzle body (10), wherein, the molded outlet opening is configured such that during operation of the window wash nozzle, a fan-shaped liquid jet or a liquid jet oscillating in a fan-shaped manner is discharged through the molded outlet opening, wherein the supply duct is furthermore connected to at least one drilled outlet opening of the nozzle body, the drilled outlet opening configured so that a non-oscillating liquid spot jet is discharged from the drilled outlet opening during operation of the window wash nozzle.

19. The window wash nozzle as claimed in claim 18, wherein the at least one drilled outlet opening has been introduced into the nozzle body by laser drilling.

20. The window wash nozzle as claimed in claim 18, wherein at least one distribution duct, which is connected to the supply duct, is formed in the nozzle body, wherein the at least one drilled outlet opening is connected to the at least one distribution duct.

21. The window wash nozzle as claimed in claim 18, wherein the nozzle body has at least one convexly curved outer surface, wherein the at least one drilled outlet opening passes through the convexly curved outer surface.

22. The window wash nozzle as claimed in claim 21, wherein an interaction chamber, which is connected at a first end to the supply duct and at a second end to the first outlet opening, is formed in the nozzle body, wherein the interaction chamber is configured such that varying vortices are formed in the interaction chamber during operation of the window wash nozzle such that a liquid jet oscillating in a fan-shaped manner is discharged from the first outlet opening.

23. The window wash nozzle as claimed in claim 18, wherein said window wash nozzle has been produced by a method as claimed in claim 1.
